(19) United States
(12) Patent Application Publication
(10) Pub. No.: US 2017/0236069 A1
(43) Pub. Date: Aug. 17, 2017

(54) SCALABLE SUPERVISED HIGH-ORDER PARAMETRIC EMBEDDING FOR BIG DATA VISUALIZATION

(71) Applicant: NEC Laboratories America, Inc., Princeton, NJ (US)

(72) Inventor: Renqiang Min, Princeton, NJ (US)

(21) Appl. No.: 15/365,631

(22) Filed: Nov. 30, 2016

Related U.S. Application Data
(60) Provisional application No. 62/293,968, filed on Feb. 11, 2016.

(51) Int. Cl. G06N 99/00; G06F 17/30

(52) U.S. Cl. CPC G06N 99/005; G06F 17/30572

(57) ABSTRACT

A method is provided for scalable supervised high-order parametric embedding for big data visualization. The method is performed by a processor and includes receiving feature vectors and class labels. Each feature vector is representative of a respective one of a plurality of high-dimensional data points. The class labels denote classes for the high-dimensional data points. The method further includes multiplying each feature vector by one or more factorized high-order tensors to obtain respective product vectors. The method also includes performing a maximally collapsing metric learning on the product vectors using learned synthetic exemplars and learned high-order filters. The learned high-order filters represent high-order embedding parameters. The method additionally includes performing an output operation to output a set of data that includes (i) interpretable factorized high-order filters, (ii) exemplars representative of the class labels and data separation properties in two-dimensional space, and (iii) a two-dimensional embedding of the high-dimensional data points.

### RELATED APPLICATION INFORMATION

This application claims priority to U.S. Provisional Pat. App. Ser. No. 62/293,968 filed on Feb. 11, 2016, incorporated herein by reference in its entirety.

### BACKGROUND

Technical Field

The present invention relates to data processing and more particularly to scalable supervised high-order parametric embedding for big data visualization.

Description of the Related Art

High-order feature interactions are present in many types of data including, for example, image, financial analysis, bioinformatics, and so forth. These interplays often convey essential information about the structures of the datasets of interest. Thus, for data visualization, it is important to preserve these high-order characteristic features in the low-dimensional latent space. Also, data visualization will be more desirable if the mapping has a parametric form and bears attractive interpretability. A parametric form for the embedding can avoid the need to develop out-of-sample extension as in the cases of non-parametric methods, while better interpretability allows people to make good sense of the data through visualization or to acquire interpretative knowledge out of the visualization.

Unfortunately, attempts for high-order embedding to attain these goals have been unsatisfactory. This is partially due to the difficulties of employing the right forms to effectively model high-order interactions and finding the efficient computation strategy to calculate such computationally expensive mappings. Deep learning models are powerful but the learned high-order interactions are hard to interpret.

Thus, there is a need for scalable supervised high-order parameter embedding for big data visualization.

### SUMMARY

According to an aspect of the present invention, a computer-implemented method is provided for scalable supervised high-order parametric embedding for big data visualization. The method includes receiving, by a processor, feature vectors and class labels. Each of the feature vectors is representative of a respective one of a plurality of high-dimensional data points. The class labels denote classes for the high-dimensional data points. The method further includes multiplying, by the processor, each of the feature vectors by one or more factorized high-order tensors to obtain respective product vectors. The method also includes performing, by the processor, a maximally collapsing metric learning on the product vectors using learned synthetic exemplars and learned high-order filters. The learned high-order filters represent high-order embedding parameters. The method additionally includes performing, by the processor, an output operation to output a set of data that includes (i) interpretable factorized high-order filters, (ii) exemplars representative of the class labels and data separation properties in two-dimensional space, and (iii) a two-dimensional embedding of the high-dimensional data points.

According to another aspect of the present invention, a computer program product is provided for scalable supervised high-order parametric embedding for big data visualization. The computer program product includes a non-transitory computer readable storage medium having program instructions embodied therewith. The program instructions are executable by a computer to cause the computer to perform a method. The method includes receiving, by a processor, feature vectors and class labels. Each of the feature vectors is representative of a respective one of a plurality of high-dimensional data points. The class labels denote classes for the high-dimensional data points. The method further includes multiplying, by the processor, each of the feature vectors by one or more factorized high-order tensors to obtain respective product vectors. The method also includes performing, by the processor, a maximally collapsing metric learning on the product vectors using learned synthetic exemplars and learned high-order filters. The learned high-order filters represent high-order embedding parameters. The method additionally includes performing, by the processor, an output operation to output a set of data that includes (i) interpretable factorized high-order filters, (ii) exemplars representative of the class labels and data separation properties in two-dimensional space, and (iii) a two-dimensional embedding of the high-dimensional data points.

According to yet another aspect of the present invention, a system is provided for scalable supervised high-order parametric embedding for big data visualization. The system includes a processor. The processor is configured to receive feature vectors and class labels. Each of the feature vectors is representative of a respective one of a plurality of high-dimensional data points. The class labels denote classes for the high-dimensional data points. The processor is further configured to multiply each of the feature vectors by one or more factorized high-order tensors to obtain respective product vectors. The processor is also configured to perform a maximally collapsing metric learning on the product vectors using learned synthetic exemplars and learned high-order filters. The learned high-order filters represent high-order embedding parameters. The processor is additionally configured to perform an output operation to output a set of data that includes (i) interpretable factorized high-order filters, (ii) exemplars representative of the class labels and data separation properties in two-dimensional space, and (iii) a two-dimensional embedding of the high-dimensional data points.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a block diagram of an exemplary processing system 100 to which the present invention may be applied, in accordance with an embodiment of the present invention;

FIG. 2 shows a block diagram of an exemplary environment 200 to which the present invention can be applied, in accordance with an embodiment of the present invention; and

FIGS. 3-4 show a flow diagram of an exemplary method 300 for scalable supervised high-order parametric embedding for big data visualization, in accordance with an embodiment of the present invention.

### DETAILED DESCRIPTION OF PREFERRED EMBODIMENTS

The present invention is directed to resilient battery charging strategies to scalable supervised high-order parametric embedding for big data visualization.

In an embodiment, a High-Order Parametric Embedding (HOPE) approach is provided. In an embodiment, the present invention targets supervised data visualization with two novel techniques. In the first technique, a series of (interaction) matrices are deployed to model the higher-order interplays in the input space. As a result, the high-order interactions are preserved in reduced low-dimensional latent space, and can be explicitly represented by these interaction matrices. In the second technique, a matrix factorization technique is leveraged and an exemplar learning strategy is tailored for the computation of the interaction matrices. The matrix factorization significantly speeds up the computation of the interaction matrices. Also, the exemplar learning strategy constructs a small number of synthetic examples to represent the whole data set, thus enabling the pairwise neighborhood computation to be effectively approximated by using this small set of synthetic examples. Consequently, the higher-order parametric embedding can be efficiently scaled to high dimensional, large-scale datasets.

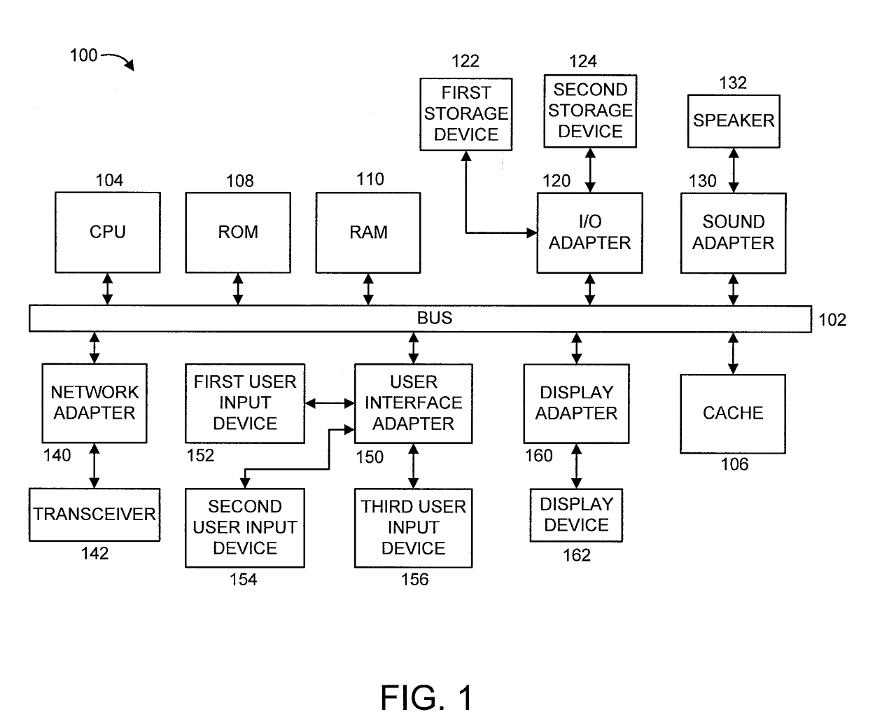

FIG. 1 shows a block diagram of an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. The speaker 132 can be used to provide an audible alarm or some other indication relating to resilient battery charging in accordance with the present invention. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

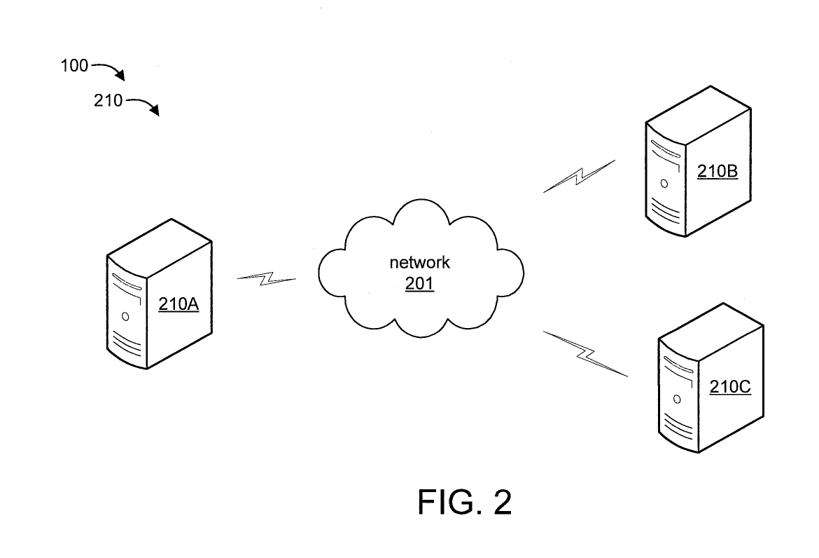

Moreover, it is to be appreciated that environment 200 described below with respect to FIG. 2 is an environment for implementing respective embodiments of the present invention. Part or all of processing system 100 may be implemented in one or more of the elements of environment 200.

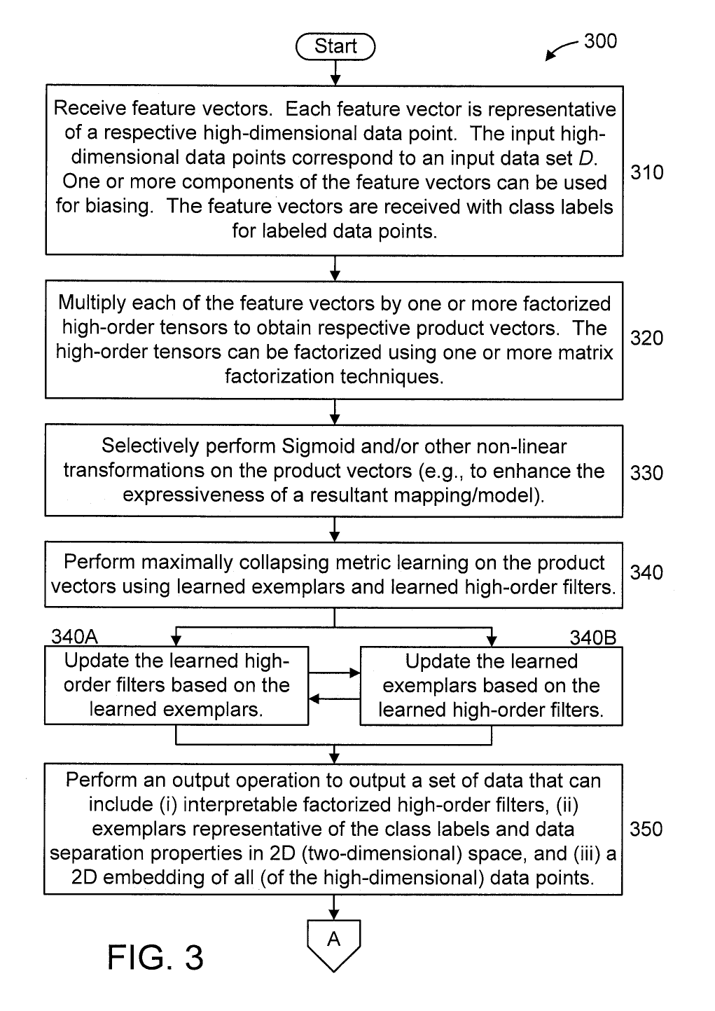

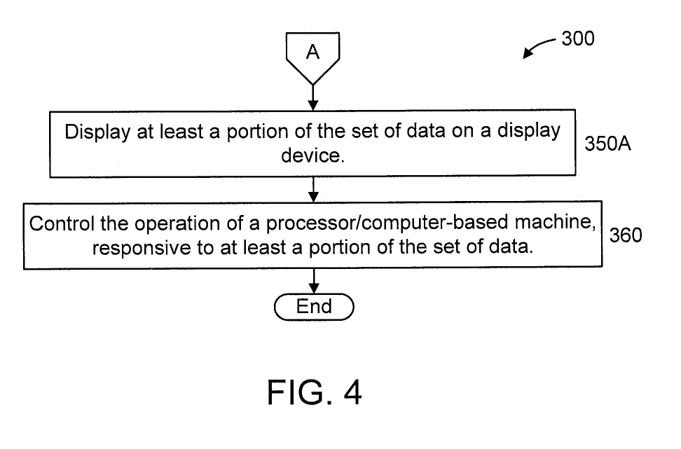

Further, it is to be appreciated that processing system 100 may perform at least part of the method described herein including, for example, at least part of method 300 of FIGS. 3-4. Similarly, part or all of system 200 may be used to perform at least part of method 300 of FIGS. 3-4.

FIG. 2 shows an exemplary environment 200 to which the present invention can be applied, in accordance with an embodiment of the present invention. The environment 200 is representative of a computer network to which the present invention can be applied. The elements shown relative to FIG. 2 are set forth for the sake of illustration. However, it is to be appreciated that the present invention can be applied to other network configurations as readily contemplated by one of ordinary skill in the art given the teachings of the present invention provided herein, while maintaining the spirit of the present invention.

The environment 200 at least includes a set of computer processing systems 210. The computer processing systems 210 can be any type of computer processing system including, but not limited to, servers, desktops, laptops, tablets, smart phones, media playback devices, and so forth. For the sake of illustration, the computer processing systems 210 include server 210A, server 210B, and server 210C.

In an embodiment, the present invention performs scalable supervised high-order parametric embedding for big data visualization for any of the computer processing systems 210. Thus, any of the computer processing systems 210 can perform data compression in both feature and sample spaces for learning from large scale datasets that can be stored in, or accessed by, any of the computer processing systems 210. Moreover, the output (including a data visualization) of the present invention can be used to control other systems and/or devices and/or operations and/or so forth, as readily appreciated by one of ordinary skill in the art given the teachings of the present invention provided herein, while maintaining the spirit of the present invention.

In the embodiment shown in FIG. 2, the elements thereof are interconnected by a network(s) 201. However, in other embodiments, other types of connections can also be used. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of environment 200 are readily determined by one of ordinary skill in the art, given the teachings of the present invention provided herein, while maintaining the spirit of the present invention.

FIGS. 3-4 show a flow diagram of an exemplary method 300 for scalable supervised high-order parametric embedding for big data visualization, in accordance with an embodiment of the present invention.

At step 310, receive feature vectors. Each of the feature vectors is representative of a respective high-dimensional data point. The input high-dimensional data points correspond to an input data set D. In an embodiment, one or more components (e.g., a last component) of the feature vectors is used for biasing (e.g., for absorbing bias terms). The feature vectors are received with class labels for labeled data points.

At step 320, multiply each of the feature vectors by one or more factorized high-order tensors to obtain respective product vectors. The high-order tensors are factorized in order to speed up the respective multiplications (by reducing computational complexity). Additionally, the high-order tensors are factorized to selectively and explicitly model different orders of feature interactions in the data responsive to a user-specified parameter O. The high-order tensors can be factorized using one or more matrix factorization techniques.

At step 330, selectively perform Sigmoid and/or other non-linear transformations on the product vectors. The Sigmoid and/or other non-linear transformations are performed to enhance the expressiveness of a resultant mapping/model. Thus, the Sigmoid and/or other non-linear transformations are selectively performed based on the implementation.

At step 340, perform maximally collapsing metric learning on the (transformed or non-transformed) product vectors. The maximally collapsing metric learning involves learned exemplars (also interchangeably referred to herein as “learned synthetic exemplars” or “synthetic exemplars”) and learned high-order filters (also interchangeably referred to herein as “learned high-order embedding parameters” or “high-order embedding parameters” or “embedding parameters” in short).

The learned exemplars do not exist in, but are nonetheless learned from, the same input data set D from which the feature vectors received at step 310 were determined (extracted). The exemplars can be learned using, e.g., supervised k-means and/or joint optimization (of the exemplars and high-order embedding parameters).

The learned high-order filters are used to map the high-dimensional data points to a low-dimensional space (by maximally collapsing classes) corresponding to the high-dimensional data points.

In an embodiment, to maximally collapse classes (corresponding to the data points of the feature vectors), the embedding parameters are learned by minimizing the sum of the Kullback-Leibler divergence between the conditional probabilities computed in the embedding space and the “ground-truth” probabilities calculated based on the class labels of training data. By maximally collapsing classes, data points in the same class stay tightly close to each other and data points from different classes stay farther apart from each other.

In an embodiment, step 340 includes steps 340A and 340B.

At step 340A, update the learned high-order filters based on the learned exemplars.

At step 340B, update the learned exemplars based on the learned high-order filters.

It is to be appreciated that steps 340A and 340B may be performed iteratively in the beginning of the optimization and simultaneously afterwards.

At step 350, perform an output operation to output a set of data. In an embodiment, the set of data can include the following: (i) interpretable factorized high-order filters; (ii) exemplars representative of the class labels and data separation properties in 2D (two-dimensional) space; and (iii) a 2D embedding of all (of the high-dimensional) data points. The interpretable factorized high-order filters are interpretable with regard to how individual features form interactions (polynomials) of a user-specified order O. The learned factorized weight vectors are high-order filters. By simply checking the absolute values of components of each weight vector, we know how important each feature is and how features form high-order interactions in a combinatorial way (if we want to, we can calculate the coefficients associated with different polynomial terms by standard polynomial expansions such as (C^{T}x)³).

In an embodiment, step 350 includes step 350A.

At step 350A, display at least a portion of the set of data on a display device.

At step 360, control the operation of a processor/computer-based machine, responsive to at least a portion of the set of data. For example, the data set may show an impending failure, in which case the processor/computer-based machine may be controlled to shut off a device or portion of a device or an application running thereon that will likely fail soon. These and other types of operations are readily determined by one of ordinary skill in the art, given the teachings of the present invention provided herein, while maintaining the spirit of the present invention.

A further description of the present invention will now be provided. In an embodiment, the present invention provides a shallow supervised t-distributed data embedding (sst-DE) method to jointly cope with dimensionality reduction and data compression using parametric forms. That is, the sst-DE approach learns a supervised t-distributed data embedding with high-order feature interactions, while simultaneously compressing the dataset with a small number of synthetic exemplars. In an embodiment, we linearly map explicit high-order (such as k-order) interaction features, which are the products of all possible k features, to low dimensional space for embedding and visualization. The intent is that all pairwise data points in the same class stay together and pairwise data points from different classes stay farther apart. Consequently, the high-order interactions are preserved in the low-dimensional space, and can also be explicitly represented by these feature interaction filters. For example, the explicit high-order interactions, which are hidden in the data, can be directly computed. Associated with the generation of these high-order features, exemplar learning techniques are devised to create a small set of exemplars tightly connected with the formed embeddings to compress the entire dataset. Hence, just these exemplars can be to perform fast information retrieval such as the widely adopted kNN classification, instead of using the whole data set, to speed up computation and gain insight into the characteristic features of the data.

A description will now be given regarding Supervised t-Distributed Data Embedding and Compression, in accordance with an embodiment of the present invention.

The description will commence with a description of a shallow embedding method with high-order feature interactions, in accordance with an embodiment of the present invention.

Given a set of data points D={x⁽ⁱ⁾, L⁽ⁱ⁾:i=1, . . . n}, where x⁽ⁱ⁾εR^{H} is the input feature vector with the last component being 1 for absorbing bias terms, L⁽ⁱ⁾ε{1, . . . , c} is the class label of labeled data points, and c is the total number of classes. sst-DE intends to find a high-order parametric embedding function y⁽ⁱ⁾=f(x⁽ⁱ⁾) that maps high-dimensional data points x⁽ⁱ⁾ to a low-dimensional space y⁽ⁱ⁾εR^{h} (h<H) by maximally collapsing classes (MCML), where it is expected that data points in the same class stay tightly close to each other and data points from different classes stay farther apart from each other. For data visualization, we often set h=2. A stochastic neighbourhood criterion is deployed to compute the pairwise similarity of data points in the low-dimensional embedding space. In this setting, the similarity of two embedded data points y⁽ⁱ⁾ and y⁽ⁱ⁾ are measured by a probability q_{i|j}. The q_{j|i} indicates the chance of the data point y⁽ⁱ⁾ assigns y^{(j)} as its nearest neighbor in the low-dimensional embedding space. A heavy-tailed t-distribution is used to compute q_{j|i} for supervised embedding due to its capabilities of reducing overfitting, creating tight clusters, increasing class separation, and easing gradient optimization. Formally, this stochastic neighborhood metric first centers a t-distribution over y⁽ⁱ⁾, and then computes the density of y^{(j)} under the distribution as follows:

$$\begin{matrix}{q}_{j \vert i} = \frac{{( 1 + {d}_{ij} )}^{- 1}}{{\sum }_{kl : k \neq l} {( 1 + {d}_{kl} )}^{- 1}} , {q}_{ii} = 0 , & ( 1 ) \\ {d}_{ij} = {‖ {y}^{( i )} - {y}^{( j )} ‖}^{2} . & ( 2 )\end{matrix}$$

To maximally collapse classes, the embedding parameters of sst-DE are learned by minimizing the sum of the Kullback-Leibler divergence between the conditional probabilities computed in the embedding space and the “ground-truth” probabilities p_{j|i} calculated based on the class labels of training data. Specifically, p_{j|i}∝1 iff L⁽ⁱ⁾=L^{(j)} and p_{j|i}=0 iff L⁽ⁱ⁾≠L^{(j)}. Formally, the objective function of the sst-DE is as follows:

$$𝓁 = {\sum }_{ij : i \neq j} {p}_{j \vert i} log \frac{{p}_{j \vert j}}{{q}_{j \vert i}} ∝ - {\sum }_{ij : i \neq j} [ {L}^{( i )} = {L}^{( j )} ] log {q}_{j \vert i} + const , \qquad ( 3 )$$

where [·] is an indicator function. The above objective function essentially maximizes the product of pairwise probabilities between data points in the same class, which creates favorable tight clusters that are suitable for supervised two-dimensional embedding in limited accommodable space. Unlike previous linear methods that directly embed original input features x, sst-DE assumes that high-order feature interactions are essential for capturing structural knowledge and learns a similarity metric directly based on these feature interactions. Suppose that sst-DE directly embeds O-order feature interactions, i.e., the products of all possible O features {xᵢ_{₁}× . . . ×xᵢ_{ₜ}× . . . ×xᵢ_{_{O}}} where tε{1, . . . , O}, and {i₁, . . . , iₜ, . . . , i_{O}}ε{1, . . . , H}. A straightforward approach is to explicitly calculate all these O-order feature interactions and use them as new input feature vectors of data points, and then learn a linear projection matrix U to map them to a h-dimensional space as follows:

$$y = {U}^{T} [ \begin{matrix}{x}_{1} \times … \times {x}_{1} \times … \times {x}_{1} \\ ⋮ \\ {x}_{{i}_{1}} \times … \times {x}_{{i}_{t}} \times … \times {x}_{{i}_{O}} \\ ⋮ \\ {x}_{H} \times … \times {x}_{H} \times … \times {x}_{H}\end{matrix} ] \qquad ( 4 )$$

where UεR^{H}^{^{O}}^{×h}, and yεR^{h} is the low-dimensional embedding vector. The above equation can be rewritten in the following equivalent tensor form:

$${y}_{s} = {\sum }_{{i}_{1} … {i}_{t} … {i}_{O}} {T}_{{i}_{1} … {i}_{t} … {i}_{O} s} {x}_{{i}_{1}} \times … \times {x}_{{i}_{t}} \times … \times {x}_{{i}_{O}} , \qquad ( 5 )$$

where T is a (O+1)-way tensor, s=1, . . . , h. However, it Is very expensive to enumerate all possible O-order feature interactions. For example, if H=1000, O=3, we must deal with a 10⁹-dimensional vector of high-order features. To speed up computation, the tensor T is factorized as follows (we use C_{f} as a column vector to refer to the f-th row of matrix C throughout this application draft, then C_{fi} is a scalar referring to the element at the f-th row and i-th column of C):

$${T}_{{i}_{1} … {i}_{t} … {i}_{O} s} = {\sum }_{f = 1}^{F} {C}_{{fi}_{1}}^{( 1 )} \times … \times {C}_{{fi}_{t}}^{( t )} \times … \times {C}_{{fi}_{O}}^{( O )} \times {P}_{fs} , \qquad ( 6 )$$

where F is the number of factors, C^{(t)}εR^{F×H}, PεR^{F×h}, and t=1, . . . , O. If C⁽¹⁾= . . . =C^{(t)}= . . . =C^{(O)}=C is enforced, the s-th high-order embedding coordinate in Equation (5) can be rewritten as follows:

$$\begin{matrix}{y}_{s} = {\sum }_{{i}_{1} … {i}_{t} … {i}_{O}} {\sum }_{f = 1}^{F} {C}_{{fi}_{1}}^{( 1 )} \times … \times {C}_{{fi}_{t}}^{( t )} \times … \times \\ {C}_{{fi}_{O}}^{( O )} \times {P}_{fs} \times {x}_{{i}_{1}} \times … \times {x}_{{i}_{t}} \times … \times {x}_{{i}_{O}} , \\ = {\sum }_{f = 1}^{F} {P}_{fs} \times ( {\sum }_{{i}_{1} = 1}^{H} {C}_{{fi}_{1}}^{( 1 )} {x}_{{i}_{1}} ) \times … \times \\ ( {\sum }_{{i}_{t} = 1}^{H} {C}_{{fi}_{t}}^{( t )} {x}_{{i}_{t}} ) \times … \times ( {\sum }_{{i}_{O} = 1}^{H} {C}_{{fi}_{O}}^{( O )} {x}_{{i}_{O}} ) \\ = {\sum }_{f = 1}^{F} {{P}_{fs} ( {\sum }_{i = 1}^{h} {C}_{fi} {x}_{i} )}^{O} \\ = {\sum }_{f = 1}^{F} {{P}_{fs} ( {C}_{f}^{T} x )}^{O}\end{matrix} \qquad ( 7 )$$

where s=1, . . . , h. With the above constrained tensor factorization, the linear embedding for any high-order interaction features of any high-dimensional data can be easily calculated by a simple operation, that is, a linear projection followed by a power operation. It is worth noting that, the above factorization form not only reduces computational complexity significantly, but also is amenable to explicitly model different order of feature interactions in the data with a user-specified parameter O.

The above method described so far has an explicit high-order parametric form for mapping and is essentially equivalent to a linear model with all explicit high-order feature interactions expanded as shown above. Compared to supervised deep embedding methods with complicated deep architectures, the above linear projection method has limited modeling power but an easily understandable form. The presented model so far is referred to as a linear shallow t-distributed data embedding (1st-DE). There is a very simple way to significantly enhance this model's expressive power, that is, by simply adding Sigmoid transformations to the above factorized model before performing linear projection. Thereby, the proposed model of the present invention is obtained, namely sigmoid shallow t-distributed data embedding (sst-DE). In sst-DE, the s-th coordinate of the low-dimensional embedding vector y is computed as follows:

$${y}_{s} = {\sum }_{k = 1}^{m} {W}_{sk} σ ( {\sum }_{f = 1}^{F} {{w}_{fk} ( {C}_{f}^{T} x )}^{O} + {b}_{k} ) , \qquad ( 8 )$$

where bₖ is the bias term, WεR^{h×m} and

$$σ ( x ) = \frac{1}{1 + {e}^{- x}} .$$

Conjugate Gradient Descent is used to optimize the objective function in Equation (3) to learn the parameters of sst-DE and its linear version 1st-DE. Although sst-DE shares the same objective as MCML and dt-MCML, sst-DE learns a shallow explicit high-order embedding function. On the contrary, MCML aims at a linear mapping over original input features, while dt-MCML targets a complicated deep nonlinear function parameterized by a deep neural network.

A description will now be given regarding scalable exemplar learning for data compression and fast kNN classification, in accordance with an embodiment of the present invention.

In addition to learning explicit high-order feature interactions for data embedding, the present invention synthesizes a small set of exemplars that do not exist in the training set for data compression, so that fast information retrieval such as kNN classification can be efficiently performed in the embedding space when the dataset is huge. Given the same dataset D with formal descriptions as introduced earlier, the intent is to learn z exemplars for the whole dataset with their designated class labels uniformly sampled from the training set to account for data label distribution, where z is a user-specified free parameter and z<<n. These exemplars are denoted by {e^{(j)}:j=1, . . . , z}. Two approaches are proposed for exemplar learning. The first one is straightforward and relies on supervised k-means. In an embodiment, k-means is performed on the training data to identify the same number of exemplars as in the sampling step for each class. If a powerful feature mapping such as the one in Equation (8) is learned and all the data points in the same class will be mapped to a compact point cloud in the two-dimensional space for some cases, this simple exemplar learning approach might achieve good performance; Otherwise, further optimization over the exemplars is needed. The second approach is based on a joint optimization. The high-order embedding parameters and the exemplars are jointly learned by optimizing the following objective function:

$${min}_{Q , \{ {e}_{j} \}} 𝓁 ( Q , \{ {e}_{j} \} ) = {\sum }_{i = 1}^{n} {\sum }_{j = 1}^{z} {p}_{j \vert i} log \frac{{p}_{j \vert i}}{{q}_{j \vert i}} \\ ∝ - {\sum }_{i = 1}^{n} {\sum }_{j = 1}^{z} [ {L}^{( i )} = {L}^{( j )} ] log {q}_{j \vert i} + const \qquad ( 9 )$$

where i indexes training data points, j indexes exemplars, Q denotes the high-order embedding parameters, p_{j|i} is calculated in the same way as in the previous description, but q_{j|i} is calculated with respect to exemplars as follows:

$$\begin{matrix}{q}_{j \vert i} = \frac{{( 1 + {d}_{ij} )}^{- 1}}{{\sum }_{k = 1}^{z} {( 1 + {d}_{ik} )}^{- 1}} , & ( 10 ) \\ {d}_{ij} = {‖ f ( {x}^{( i )} ) - f ( {e}^{( j )} ) ‖}^{2} , & ( 11 )\end{matrix}$$

where f(·) denotes the high-order embedding function as described in Equations (7) and (8). Note that unlike the symmetric probability distribution in Equation (1), the asymmetric q_{j|i} here is computed only using the pairwise distances between training data points and exemplars. Since z<<n, it saves us a lot of computations compared to using the original distribution in Equation (1). The derivative of the above objective function with respect to exemplar e^{(j)} is as follows:

$$\frac{\partial 𝓁 ( Q , {e}_{k} \} )}{\partial {e}^{( j )}} = {\sum }_{i = 1}^{n} 2 {( 1 + {d}_{ij} )}^{- 1} ( {p}_{j \vert i} - {q}_{j \vert i} ) \\ ( f ( {e}^{( j )} ) - f ( {x}^{( i )} ) ) \frac{\partial f ( {e}^{( j )} )}{\partial {e}^{( j )}} \qquad ( 12 )$$

The derivatives of other model parameters can be easily calculated similarly. These synthetic exemplars and the embedding parameters of sst-DE and 1st-DE are updated in a deterministic Expectation-Maximization fashion using Conjugate Gradient Descent. In specific, the exemplars belonging to each class are initialized by the first exemplar learning approach. During the early phase of the joint optimization of exemplars and high-order embedding parameters, the learning process alternatively fixes one while updating the other. Then the algorithm updates all the parameters simultaneously until reaching convergence or the specified maximum number of epochs.

A description will now be given regarding specific competitive/commercial values of the solution achieved by the present invention.

For example, experimental results on the benchmarking MNIST and USPS data sets demonstrate the superior performance of the sst-DE (HOPE) strategy, in terms of effectiveness and scalability. In particular, the present invention's modeling of high-order interactions in the data significantly improves data visualization in low-dimensional latent space, particularly when compared with its low-order interaction counterparts. Moreover, HOPE enables the visualization of different orders of interactions in the data, thus being able to help gain more insights into the structures hidden in the data.

For supervised data visualization, the present invention is complementary to existing state-of-the-art techniques. Specifically, HOPE can capture explicit high-order interactions with exact matrix forms, thus bearing enhanced interpretable properties.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for scalable supervised high-order parametric embedding for big data visualization, the method comprising:
receiving, by a processor, feature vectors and class labels, each of the feature vectors being representative of a respective one of a plurality of high-dimensional data points, the class labels denoting classes for the high-dimensional data points;
multiplying, by the processor, each of the feature vectors by one or more factorized high-order tensors to obtain respective product vectors;
performing, by the processor, a maximally collapsing metric learning on the product vectors using learned synthetic exemplars and learned high-order filters, the learned high-order filters representing high-order embedding parameters; and
performing, by the processor, an output operation to output a set of data that includes (i) interpretable factorized high-order filters, (ii) exemplars representative of the class labels and data separation properties in two-dimensional space, and (iii) a two-dimensional embedding of the high-dimensional data points.

2. The computer-implemented method of claim 1, wherein the high-order tensors are factorized in order to speed up respective multiplications involving the one or more factorized high-order tensors by reducing computational complexity.

3. The computer-implemented method of claim 1, wherein the high-order tensors are factorized to selectively and explicitly model different orders of feature interactions between the high-dimensional data points, responsive to a user-specified parameter.

4. The computer-implemented method of claim 1, wherein the high-order tensors are factorized using one or more matrix factorization techniques.

5. The computer-implemented method of claim 1, further comprising selectively performing one or more non-linear transformations on the product vectors to enhance the expressiveness of a resultant model formed by the method.

6. The computer-implemented method of claim 1, wherein the learned exemplars are absent in, but learned from, a same input data set that includes the high-dimensional data points from which the feature vectors and the class labels are determined.

7. The computer-implemented method of claim 6, wherein the learned exemplars are learned using a technique selected from the group consisting of a supervised k-means technique and a joint optimization of the learned synthetic exemplars and the high-order filters.

8. The computer-implemented method of claim 6, further comprising performing an information retrieval operation on only the learned synthetic exemplars in place of the input data set.

9. The computer-implemented method of claim 1, wherein the learned high-order filters are used to map the high-dimensional data points to a low-dimensional space by maximally collapsing classes corresponding to the high-dimensional data points.

10. The computer-implemented method of claim 9, wherein to maximally collapse classes, the learned high-order filters are learned by minimizing a sum of a Kullback-Leibler divergence between conditional probabilities computed in an embedding space and ground-truth probabilities calculated based on class labels of training data.

11. The computer-implemented method of claim 1, wherein the maximally collapsing metric learning comprises jointly updating the learned high-order filters and the learned synthetic exemplars.

12. The computer-implemented method of claim 1, further comprising displaying at least a portion of the set of data on a display device such that the high-dimensional data points in a same class stay closer to each other while the high-dimensional data points from different classes stay farther apart from each other to visually distinguish class members from among the different classes.

13. The computer-implemented method of claim 1, further comprising controlling an operation of a processor-based machine, responsive to at least a portion of the set of data output by the output operation.

14. The computer-implemented method of claim 1, wherein one or more components of at least some of the feature vectors is used for biasing.

15. A computer program product for scalable supervised high-order parametric embedding for big data visualization, the computer program product comprising a non-transitory computer readable storage medium having program instructions embodied therewith, the program instructions executable by a computer to cause the computer to perform a method comprising:
receiving, by a processor, feature vectors and class labels, each of the feature vectors being representative of a respective one of a plurality of high-dimensional data points, the class labels denoting classes for the high-dimensional data points;
multiplying, by the processor, each of the feature vectors by one or more factorized high-order tensors to obtain respective product vectors;
performing, by the processor, a maximally collapsing metric learning on the product vectors using learned synthetic exemplars and learned high-order filters, the learned high-order filters representing high-order embedding parameters; and
performing, by the processor, an output operation to output a set of data that includes (i) interpretable factorized high-order filters, (ii) exemplars representative of the class labels and data separation properties in two-dimensional space, and (iii) a two-dimensional embedding of the high-dimensional data points.

16. The computer program product of claim 15, wherein the learned exemplars are absent in, but learned from, a same input data set that includes the high-dimensional data points from which the feature vectors and the class labels are determined.

17. The computer program product of claim 16, wherein the learned exemplars are learned using a technique selected from the group consisting of a supervised k-means technique and a joint optimization of the learned synthetic exemplars and the high-order filters.

18. The computer program product of claim 16, wherein the method further comprises performing an information retrieval operation on only the learned synthetic exemplars in place of the input data set.

19. The computer program product of claim 15, wherein the method further comprises controlling an operation of a processor-based machine, responsive to at least a portion of the set of data output by the output operation.

20. A system for scalable supervised high-order parametric embedding for big data visualization, the system comprising:
a processor, configured to:
receive feature vectors and class labels, each of the feature vectors being representative of a respective one of a plurality of high-dimensional data points, the class labels denoting classes for the high-dimensional data points;
multiply each of the feature vectors by one or more factorized high-order tensors to obtain respective product vectors;
perform a maximally collapsing metric learning on the product vectors using learned synthetic exemplars and learned high-order filters, the learned high-order filters representing high-order embedding parameters; and
perform an output operation to output a set of data that includes (i) interpretable factorized high-order filters, (ii) exemplars representative of the class labels and data separation properties in two-dimensional space, and (iii) a two-dimensional embedding of the high-dimensional data points.
